(19) United States
(12) Patent Application Publication
(10) Pub. No.: US 2013/0206671 A1
(43) Pub. Date: Aug. 15, 2013

(54) Water Electrolysis Treatment Device

(71) Applicants: Tomonori Ohira, Tokyo (JP); Shinya Onoue, Tokyo (JP); Kenji Kawashima, Tokyo (JP)

(72) Inventors: Tomonori Ohira, Tokyo (JP); Shinya Onoue, Tokyo (JP); Kenji Kawashima, Tokyo (JP)

(73) Assignees: TOMO INTERNATIONAL CO., LTD., Tokyo (JP); KAWASHIMA CO., LTD., Gunma (JP); TOMO CHEMICAL CO., LTD., Tokyo (JP)

(21) Appl. No.: 13/877,198

(22) PCT Filed: Oct. 12, 2011
(86) PCT No.: PCT/JP2011/073432

§ 371 Date: Apr. 1, 2013

(30) Foreign Application Priority Data
Oct. 13, 2010 (JP) 2010-230947

(51) Int. Cl. C02F 1/469

(52) U.S. Cl. CPC C02F 1/4695
USPC 210/321.6

(57) ABSTRACT

A water electrolysis apparatus is provided that can stably produce water with high purity while preventing soiling and breakage, allows easy handling, detachment, and replacement, and allows inexpensive manufacture and maintenance. The water electrolysis apparatus includes: a treatment vessel; an anion cylinder having a cylindrical negative ion permeable membrane provided in the treatment vessel; a cation cylinder having a cylindrical positive ion permeable membrane provided in the treatment vessel; an anode provided in the cylindrical negative ion permeable membrane in an axial direction of the cylinder; and a cathode provided in the cylindrical positive ion permeable membrane in an axial direction of the cylinder, water to be treated stored in the treatment vessel can flow in an axial direction of the cylinder of the anion cylinder and the cation cylinder in the treatment vessel, and ion concentrated water with concentrated ions is obtained in the anion cylinder and the cation cylinder, and pure water is obtained in the treatment vessel.

### TECHNICAL FIELD

The present invention relates to a water electrolysis apparatus that electrolyzes water containing ions to obtain fresh water and various ions.

### BACKGROUND ART

Conventionally, various techniques have been studied removing ions from water to be treated containing ions, for example, such as seawater, to obtain water such as drinking water. Among these techniques, various water electrolysis techniques have been developed applying electric power to water to be treated via an electrode, attracting ions to the electrode, and removing the ions from the water to be treated. The water electrolysis techniques have been noted because these techniques can arbitrarily remove ions depending on electric power applied, and thus can increase the purity of water after treatment and can obtain electrolysis water or substances as ion components (for seawater, sodium, chlorine, salt, hypochlorous acid having sterilizing activity, or the like) by water electrolysis. Among the water electrolysis techniques, an electrodialysis method of concentrating ions attracted to an electrode through a positive ion exchange membrane and a negative ion exchange membrane to remove ions from water to be treated has been used in conventional plants.

Patent Literature 1 discloses an electrodialysis apparatus in which a DC stabilizing power supply can apply a DC current or a DC voltage. Between an anode side electrode and a cathode side electrode of the electrodialysis apparatus, positive ion exchange membranes and negative ion exchange membranes are alternately provided. Between the positive ion exchange membrane and the negative ion exchange membrane, a multilayer structure having at least two chambers is provided that is divided into a desalting chamber that recovers sodium ions, potassium ions, and chlorine ions from seawater to be treated and reduces concentrations of the ions, and a concentration chamber that recovers sodium ions, potassium ions, and chlorine ions and concentrates the ions. At least one electrode liquid chamber placed between the positive ion exchange membranes is provided on an anode side, and at least one electrode liquid chamber placed between the negative ion exchange membranes is provided on a cathode side. The electrodialysis apparatus is intended to obtain concentrated ions and pure water by using ions being concentrated in the concentration chamber near the electrode, and ions being removed from the desalting chamber near a central portion.

### CITATION LIST

### Patent Literature

Patent Literature 1: Japanese Patent Laid-Open No. 2002-306118

### SUMMARY OF THE INVENTION

### Technical Problem

In the electrodialysis apparatus disclosed in Patent Literature 1, the seawater to be treated alternately passes through the negative ion exchange membrane and the positive ion exchange membrane and is concentrated, and thus a spot where the water to be treated is nearly neutral is created in the apparatus immediately after the water passes through the cathode and the anode the same number of times, or the like. On the spot, salt or impurities contained in the water tend to deposit, which may cause clogging or soiling of the ion exchange membrane, and breakage of the ion exchange membrane due to an increase in pressure of the seawater caused by the clogging or soiling. Such breakage of the ion exchange membrane or leakage reduces purity of pure water, and also maintenance such as replacement of the expensive ion exchange membrane is frequently required, which increases maintenance cost. Further, the planar ion exchange membranes alternately loaded are detached for maintenance, which is difficult and very troublesome, and a maintenance operation itself may cause breakage of the ion exchange membrane or the apparatus.

Accordingly, the present invention has an object to provide a water electrolysis apparatus that can stably produce water with high purity while preventing soiling and breakage.

The present invention has another object to provide a water electrolysis apparatus that allows easy manufacture, handling, detachment, and replacement, and allows inexpensive manufacture and maintenance.

### Solution to Problem

The present invention provides a water electrolysis apparatus including: a treatment vessel; at least one anion cylinder having a cylindrical negative ion permeable membrane provided in the treatment vessel; at least one cation cylinder having a cylindrical positive ion permeable membrane provided in the treatment vessel; an anode provided in the cylindrical negative ion permeable membrane in an axial direction of the cylinder; and a cathode provided in the cylindrical positive ion permeable membrane in an axial direction of the cylinder, wherein water to be treated stored in the treatment vessel can flow in an axial direction of the cylinder of the at least one anion cylinder and the at least one cation cylinder in the treatment vessel, and ion concentrated water with concentrated ions is obtained in the at least one anion cylinder and the at least one cation cylinder, and pure water is obtained in the treatment vessel.

When electrification is made between the cathode and the anode, negative ions contained in the water to be treated in the treatment vessel pass through the negative ion permeable membrane and are concentrated in the at least one anion cylinder, and the positive ions pass through the positive ion permeable membrane and are concentrated in the at least one cation cylinder. Thus, the negative ions and the positive ions are removed from the water to be treated, and pure water is obtained. Ion concentrated water with concentrated negative ions and positive ions are obtained in the anion cylinder and the cation cylinder, respectively. The negative ion permeable membrane and the positive ion permeable membrane are cylindrical, thereby providing the anion cylinder and the cation cylinder having large surface areas and high ion permeability, and also allowing easy manufacture. Since the anion cylinder and the cation cylinder having the cylindrical permeable membranes are easy to handle, detach, and replace, the ion concentrated water concentrated in the anion cylinder and the cation cylinder can be easily replaced. High safety and convenience in maintenance can also be obtained. The negative ion permeable membrane and the positive ion permeable membrane are cylindrical, and do not include a corner, a side, or a joint forming a side, thereby rarely causing soiling, contamination, breakage of the membranes, creases, and leakage from the joint. In particular, ions in equal amounts pass through any spot in the cylinder, and thus equal osmotic pressure is applied, thereby preventing a difference in permeation performance depending on spots, and facilitating adjustment in the amount of ion permeation by a surface area. Breakage or creases due to a difference in pressure depending on spots in the negative ion permeable membrane and the positive ion permeable membrane rarely occurs. Such operations allow long-term use without maintenance.

It is preferable that the water electrolysis apparatus be configured so that an amount of permeation of negative ions per unit time through the negative ion permeable membrane is equal to an amount of permeation of positive ions per unit time through the positive ion permeable membrane. The negative ions and the positive ions in respective equal amounts pass through the respective permeable membranes, thereby removing the negative ions and the positive ions in equal amounts from the water to be treated, and obtaining treated water with high purity.

The water electrolysis apparatus preferably further includes a single salt recovery vessel that is connected to an opening provided in at least one of ends of the at least one anion cylinder and the at least one cation cylinder and recovers ion concentrated water. The ions contained in the water to be treated, can be recovered in single vessel, thereby simplifying a system, providing convenient maintenance, and reducing cost. The negative ions and the positive ions are recovered in the same vessel and thus salt can be collected. In particular, when the anion cylinder and the cation cylinder collect ions in equal amounts, a liquid in the salt recovery vessel is a salt solution containing the positive ions and the negative ions in equal amounts, and is a neutral solution and easy to handle, thereby reducing cost for maintenance and recovery, and facilitating recovery of salt.

Also, the water electrolysis apparatus preferably further includes two salt recovery vessels that are respectively connected to the at least one anion cylinder and the at least one cation cylinder and recover the ion concentrated water. Components concentrated in the anion cylinder and the cation cylinder can be recovered, treated, or used.

It is preferable that the at least one anion cylinder and the at least one cation cylinder include sealing members that respectively hold at least opposite ends of the cylinders of the negative ion permeable membrane and the positive ion permeable membrane, and are configured so that at least a part of a side surface of the cylinder faces the water to be treated, and parts of the sealing members are configured to be fitted to openings so that the at least one anion cylinder and the at least one cation cylinder can be detachably held. The anion cylinder and the cation cylinder can be particularly easily replaced via the sealing members, thereby eliminating the need for effort and cost for maintenance.

The at least one anion cylinder or the at least one cation cylinder preferably includes members that can be screwed to the sealing members at opposite ends of the cylinder of the negative ion permeable membrane or the positive ion permeable membrane. The anion cylinder or the cation cylinder is assembled into a cartridge type cylinder by screwing. Thus, the cathode or the anode, and the negative ion permeable membrane or the positive ion permeable membrane can be easily replaced, soiling or wear can be easily addressed, and soiling or wear in replacement rarely occurs.

The at least one anion cylinder or the at least one cation cylinder preferably includes, at a bottom surface, a securing portion that can be screwed or fitted to the treatment vessel. The cylinder can be secured to the treatment vessel by screwing or fitting, thereby facilitating attachment and detachment.

The at least one anion cylinder and the at least one cation cylinder preferably have bottom surfaces secured to a bottom surface of the treatment vessel. The anion cylinder and the cation cylinder can be efficiently placed on the bottom surface, thereby obtaining high treatment efficiency.

It is preferable that the at least one anion cylinder and the at least one cation cylinder are a plurality of anion cylinders and a plurality of cation cylinders, and the plurality of anion cylinders and the plurality of cation cylinders are spreadingly placed to cover a part of the bottom surface of the treatment vessel. The plurality of anion cylinders and cation cylinders can be efficiently and easily placed so that a largest number of cylinders are placed per volume of the treatment vessel, thereby increasing treatment efficiency and facilitating maintenance.

It is preferable that the cathode or the anode is cylindrical with an open lower end, the at least one anion cylinder or the at least one cation cylinder includes means for supplying the ion concentrated water from an upper end of the cylinder, and means for recovering the ion concentrated water from an upper end of the positive ion permeable membrane or the negative ion permeable membrane. When the ion concentrated water is supplied from the upper end of the cylinder of the cathode or the anode, the ion concentrated water flows from the upper end to a lower end of the cathode or the anode, and then flows from a lower end to an upper end of the positive ion permeable membrane or the negative ion permeable membrane, and is recovered from the upper end of the positive ion permeable membrane or the negative ion permeable membrane. The ion concentrated water can be both supplied and recovered from the upper end of the anion cylinder or the cation cylinder, thereby simplifying a configuration of the apparatus and saving space.

### Advantageous Effects of Invention

According to the present invention, when electrification is made between the cathode and the anode, negative ions contained in the water to be treated in the treatment vessel pass through the negative ion permeable membrane and are concentrated in the at least one anion cylinder, and the positive ions pass through the positive ion permeable membrane and are concentrated in the at least one cation cylinder. Thus, the negative ions and the positive ions are removed from the water to be treated, and pure water is obtained. Ion concentrated water with concentrated negative ions and positive ions are obtained in the anion cylinder and the cation cylinder, respectively. The negative ion permeable membrane and the positive ion permeable membrane are cylindrical, thereby providing the anion cylinder and the cation cylinder having large surface areas and high ion permeability, and also allowing easy manufacture. Since the anion cylinder and the cation cylinder having the cylindrical permeable membranes are easy to handle, detach, and replace, the ion concentrated water concentrated in the anion cylinder and the cation cylinder can be easily replaced. High safety and convenience in maintenance can also be obtained. The negative ion permeable membrane and the positive ion permeable membrane are cylindrical, and do not include a corner, a side, or a joint forming a side, thereby rarely causing soiling, contamination, breakage of the membranes, creases, and leakage from the joint. In particular, ions in equal amounts pass through any spot in the cylinder, and thus equal osmotic pressure is applied, thereby preventing a difference in permeation performance depending on spots, and facilitating adjustment in the amount of ion permeation by a surface area. Breakage or creases due to a difference in pressure depending on spots in the negative ion permeable membrane and the positive ion permeable membrane rarely occurs. Such operations allow long-term use without maintenance.

### BRIEF DESCRIPTION OF DRAWINGS

FIG. 1 is a partially fragmentary perspective view of a water electrolysis apparatus according to a first embodiment of the present invention.

FIG. 2(a) is a perspective view of an anion cylinder in the water electrolysis apparatus in FIG. 1, and FIG. 2(b) is a sectional view thereof taken along the line A-A.

FIG. 3 is a partially fragmentary perspective view of a water electrolysis apparatus according to a second embodiment of the present invention.

FIG. 4(a) is a perspective view of an anion cylinder in a third embodiment of the present invention, and FIG. 4(b) is an exploded view thereof.

FIG. 5 is a side sectional view showing an operation of the anion cylinder in FIG. 4.

FIG. 6 is a partially fragmentary perspective view of a water electrolysis apparatus according to a fourth embodiment of the present invention.

### DESCRIPTION OF EMBODIMENTS

### First Embodiment

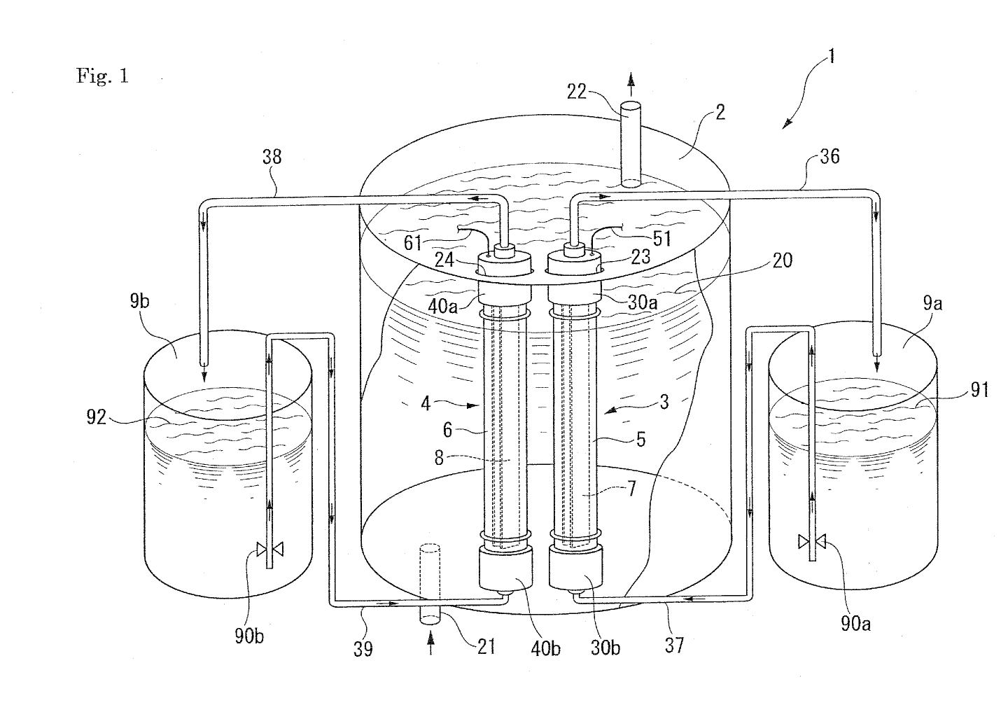

FIG. 1 is a partially fragmentary perspective view of a water electrolysis apparatus according to a first embodiment of the present invention. A water electrolysis apparatus 1 includes a treatment vessel 2, an anion cylinder 3 and a cation cylinder 4 each configured as a cartridge unit, and a negative ion recovery vessel 9a and a positive ion recovery vessel 9b as salt recovery vessels.

The treatment vessel 2 is a vessel that can store water to be treated 20. In this embodiment, the treatment vessel 2 is cylindrical and includes an inlet port 21 and an outlet port 22, the water to be treated 20 flows by being supplied from the inlet port 21 by a pump (not shown) and discharged from the outlet port 22. The water to be treated 20 includes natural water such as seawater, river water, lake water, or mineral water, and water containing impurities such as wastewater such as industrial wastewater, or water containing remaining ions such as industrial water or tap water. In this embodiment, the water to be treated 20 is water such as seawater containing salt.

The treatment vessel 2 includes openings 23, 24 through and to which the cartridge units constituted by the anion cylinder 3 and the cation cylinder 4 can be inserted and fitted and secured. In this embodiment, the circular openings 23, 24 are provided in an upper surface of the treatment vessel 2.

The anion cylinder 3 and the cation cylinder 4 primarily include a cylindrical negative ion permeable membrane 5 and a cylindrical positive ion permeable membrane 6, respectively, having smooth surfaces without any joint, and sealing members 30a, 30b that seal openings at opposite ends of the cylindrical negative ion permeable membrane 5 and the cylindrical positive ion permeable membrane 6. The negative ion permeable membrane 5 and the positive ion permeable membrane 6 are filters through which negative ions and positive ions selectively pass, respectively. In this embodiment, the negative ion permeable membrane 5 and the positive ion permeable membrane 6 are filters made of a material containing polyolefin, styrene, vinylbenzene, or the like with an ion exchange group, and have a cylindrical shape with an outer diameter of 60 mm and a length of 130 mm. The size is desirably determined depending on a relationship between an amount of ion permeation and a surface area described later, and is not limited to the above mentioned values.

The negative ion permeable membrane 5 and the positive ion permeable membrane 6 are configured so that an amount of permeation of negative ions per unit time through the negative ion permeable membrane 5 is equal to an amount of permeation of positive ions per unit time through the positive ion permeable membrane 6. Specifically, masses (g/cm²·min) of ions recovered per unit time and unit area of the membranes are calculated, and surface areas of the negative ion permeable membrane 5 and the positive ion permeable membrane 6 are respectively adjusted so as to have an equal product of the mass of the ions and the surface area (cm²). In this embodiment, masses of ions recovered for one of the anion cylinders 3 and one of the cation cylinders 4 are experimentally calculated to adjust the amount of ion permeation to be equal depending on the number of the anion cylinders 3 and the cation cylinders 4 provided. In this embodiment, the amounts of ion permeation per unit area and unit time of the negative ion permeable membrane 5 and the positive ion permeable membrane 6 are substantially equal, and thus the respective surface areas thereof are also configured to be substantially equal.

In the cylindrical negative ion permeable membrane 5, an anode 7 extending in an axial direction thereof is provided, and in the cylindrical positive ion permeable membrane 6, a cathode 8 extending in an axial direction thereof is provided. The anode 7 and the cathode 8 may be made of, without any particular limitation, any materials that allow easy electrification of the water to be treated 20, such as materials with various kinds of conductive metal or carbon, or materials with various coatings for preventing corrosion or adherence of impurities. In this embodiment, the anode 7 is mainly made of iridium oxide (TrO₂), and the cathode 8 is mainly made of titanium (Ti), each is provided by placing two plate-like electrodes adjacent to each other in a V shape, has a total area of 120 mm×50 mm and an effective area of about 1 dm². The anode 7 and the cathode 8 are connected to a power supply (not shown) via electrification lines 51, 61, respectively, to allow electrification.

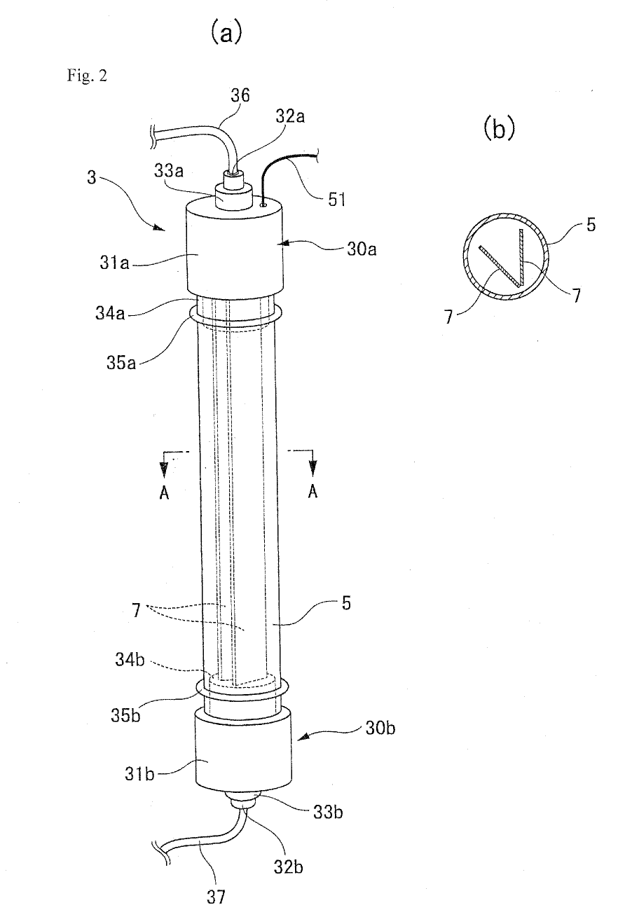

FIG. 2(a) is a perspective view of the anion cylinder 3, and FIG. 2(b) is a sectional view of the anion cylinder 3 taken along the line A-A. The anion cylinder 3 includes the sealing members 30a, 30b that seal respective openings at opposite ends of the cylindrical negative ion permeable membrane 5, and is formed as a cartridge unit. In this embodiment, the sealing members 30a, 30b are made of resin and comprise two-stepped short cylindrical shapes, and one of each sealing member is fitted to upper and lower ends, respectively, of the negative ion permeable membrane 5 to seal the openings. The sealing member 30a includes a body 31a having a larger inner diameter than an outer diameter of the negative ion permeable membrane 5, a connecting portion 33a provided at an upper end of the body 31a and having an anion cylinder outlet 32a, and a fitting portion 34a having an outer diameter substantially equal to the inner diameter of the negative ion permeable membrane 5 at a lower end of the body 31a. The fitting portion 34a is inserted and fitted into the opening in the negative ion permeable membrane 5. An outer periphery of the negative ion permeable membrane 5 at this portion is fastened by a ring-like elastic fastening member 35a made of rubber or resin to seal the opening. In the sealing member 30b that seals the opening at the lower end of the negative ion permeable membrane 5, a body 31b, an anion cylinder inlet 32b, a connecting portion 33b, a fitting portion 34b, and a fastening member 35b have the same structure. This structure provides a cartridge unit with the upper and lower ends of the negative ion permeable membrane 5 being sealed. Pipes 37, 36 are connected to the anion cylinder inlet 32b and the anion cylinder outlet 32a, respectively. The electrification line 51 electrically connected to the anode 7 is inserted into the connecting portion 33a in a sealed manner. The anode 7 is supported by the connecting portions 33a, 33b in the negative ion permeable membrane 5. The cation cylinder 4 is also formed as a cartridge unit with the same structure as the anion cylinder 3.

The anion cylinder 3 and the cation cylinder 4 formed as the cartridge units are fitted and secured to the openings 23, 24 in the treatment vessel 2. In this embodiment, the cartridge units are detachably held in the openings 23, 24 by elasticity of resin that forms the sealing member 30a of the anion cylinder 3 and the sealing member 40a of the cation cylinder 4.

The negative ion recovery vessel 9a is connected to the anion cylinder inlet 31 and the anion cylinder outlet 32 by the pipes 37, 36, respectively, and the positive ion recovery vessel 9b is connected to a cation cylinder inlet 41 and a cation cylinder outlet 42 by pipes 39, 38, respectively. Water can flow through the pipes 37, 39 by operations of pumps (not shown) provided in the negative ion recovery vessel 9a and the positive ion recovery vessel 9b and opening/closing of valves 90a, 90b.

Next, an operation of the water electrolysis apparatus 1 will be described.

When the water to be treated 20 is passed through the inlet port 21 and the outlet port 22 into the treatment vessel 2, and electrification is made between the anode 7 and the cathode 8, negative ions contained in the water to be treated 20 are attracted to the anode 7, and positive ions are attracted to the cathode 8. Only the negative ions pass through the negative ion permeable membrane 5, and thus the negative ions are concentrated in the anion cylinder 3. Only the positive ions pass through the positive ion permeable membrane 6, and thus the positive ions are concentrated in the cation cylinder 4. Thus, the negative ions and the positive ions are removed from the water to be treated 20.

In the treatment vessel 2, the water to be treated 20 flows from the inlet port 21 toward the outlet port 22 in a longitudinal direction of the anode 7 and the cathode 8 placed in the axial direction of the anion cylinder 3 and the cation cylinder 4, and thus an ion content is reduced as the flow proceeds. The water to be treated 20 is discharged from the outlet port 22 as pure water with the lowest ion content.

Ion concentrated water 91, 92 concentrated in the anion cylinder 3 and the cation cylinder 4 are collected through the pipes 36, 38, respectively, in the negative ion recovery vessel 9a and the positive ion recovery vessel 9b. In this embodiment, among ions contained in the water to be treated 20 containing salt, chloride ions are collected in the negative ion recovery vessel 9a and sodium ions are collected in the positive ion recovery vessel 9b. The ions can be collected and recovered as gaseous chlorine and metal sodium from the ion concentrated water 91 and the 92. The pumps in the negative ion recovery vessel 9a and the positive ion recovery vessel 9b may be usually stopped to close the valves 90a, 90b, and the pumps and the valves 90a, 90b may be operated only when amounts of ions in the anion cylinder 3 and the cation cylinder 4 are increased.

In this embodiment, the anion cylinder 3 and the cation cylinder 4 are formed as the cartridge units, and are easy to attach to and detach from the treatment vessel 2. This reduces breakage in replacement of members including the negative ion permeable membrane 5 and the positive ion permeable membrane 6, and facilitates maintenance. This allows low cost for placement and maintenance. From such easy placement and maintenance, the water electrolysis apparatus of this embodiment can be easily applied in various places and for various purposes, and can be used for electrodeposition coating of automobiles, building materials, and household appliances, desalting, and concentration.

In this embodiment, the anodes 7 and the cathodes 8 are each placed to form a V shape in the anion cylinder 3 and the cation cylinder 4. This can increase a surface area of the electrode as compared to a case where the anodes 7 and the cathodes 8 are placed in parallel and spaced apart,

As a variant of this embodiment, two or more sets of anion cylinders 3 and cation cylinders 4 may be provided. If the numbers of the anion cylinders 3 and the cation cylinders 4 are increased to increase a total surface area of the negative ion permeable membrane 5 and the positive ion permeable membrane 6, an amount of ions that can pass through the negative ion permeable membrane 5 and the positive ion permeable membrane 6 is increased, and amounts of salt concentrated liquids 91, 92 that can be concentrated in the anion cylinder 3 and the cation cylinder 4 are increased, thereby increasing an effect of removing ions.

The negative ion recovery vessel 9a, the positive ion recovery vessel 9b, and the pipes 36 to 39 may be omitted. Since the anion cylinder 3 and the cation cylinder 4 are detachable from the treatment vessel 2, the anion cylinder 3 and the cation cylinder 4 can be regularly detached to replace the ion concentrated liquids 91, 92 in the cylinders, thereby simplifying the structure of the apparatus.

The anode 7 and the cathode 8 may have any other shapes. For example, the anode 7 and the cathode 8 may be cylindrical with a smaller diameter than the cylinders of the negative ion permeable membrane 5 and the positive ion permeable membrane 6, and may be inserted into the negative ion permeable membrane 5 and the positive ion permeable membrane 6. For example, to increase the surface area of the electrode, the cathode 8 and the anode 7 may have a different shape such as a cylindrical shape or an X shape within a range of shapes to be housed in the diameter of the anion cylinder 3 and the cation cylinder 4.

The sealing members 30a, 30b, 40a and 40b may have any other shapes. For example, with only parts of the negative ion permeable membrane 5 and the positive ion permeable membrane 6 being exposed, the sealing members 30a, 30b, 40a and 40b may be made of resin and have cylindrical shape with a mesh-like or a grid-like side surface, and the negative ion permeable membrane 5 and the positive ion permeable membrane 6 may be inserted into the cylinders. In this case, the negative ion permeable membrane 5 and the positive ion permeable membrane 6 are protected by the sealing members 30a, 30b, 40a and 40b, thereby reducing breakage.

When water containing heavy metal, for example, a waste liquid of plating is used as the water to be treated 20, heavy metal is concentrated in the positive ion recovery vessel 9b. Thus, the water electrolysis apparatus of this embodiment can be used for removing heavy metal from water or recovering the heavy metal for recycling.

In this water electrolysis apparatus, electrolysis generates hydrogen ions, and the hydrogen ions have an action of reducing chemical substances. The reducing action can decompose substances that may affect a human body, for example, MCP (monochloro propanediol) or DCP (dichloro propanediol) that may be generated by hydrolysis of protein or high-heat treatment of fat.

### Second Embodiment

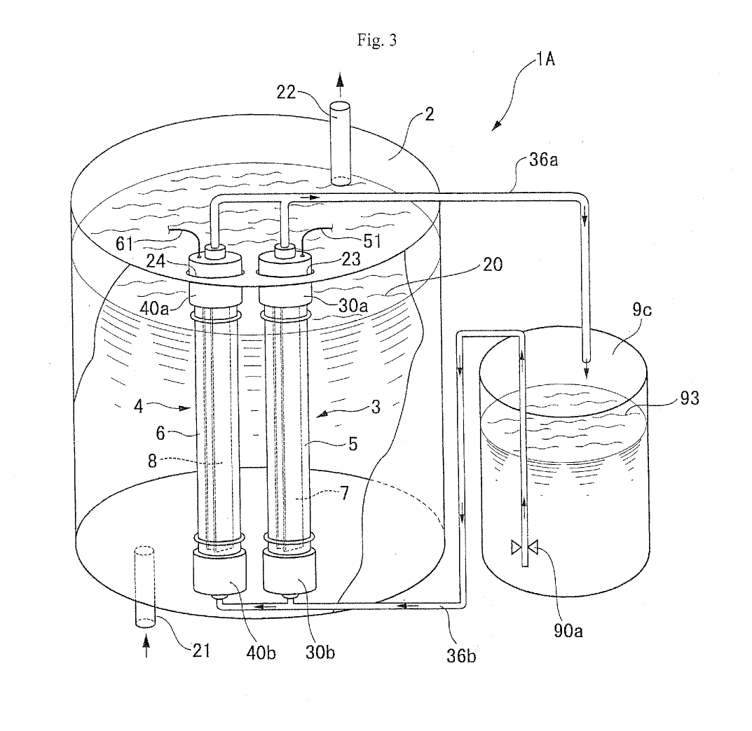

FIG. 3 is a partially fragmentary perspective view of a water electrolysis apparatus according to a second embodiment of the present invention. In this embodiment, a water electrolysis apparatus 1A includes a single salt recovery vessel 9c connected to ends of an anion cylinder 3 and a cation cylinder 4 by pipes 36b, 37b. Descriptions on components having the same configuration and operation as those in the above described embodiment will be omitted.

In this embodiment, an ion concentrated liquid 93 in the anion cylinder 3 and the cation cylinder 4 is collected in the single salt recovery vessel 9c. An amount of permeation of negative ions per unit time through the negative ion permeable membrane 5 is equal to an amount of permeation of positive ions per unit time through the positive ion permeable membrane 6, negative ions and positive ions in equal amounts are concentrated in the ion concentrated liquid 93, and thus the salt recovery vessel 9c contains negative ions and positive ions in equal amounts. In this embodiment, chloride ions and sodium ions in equal amounts are contained, and thus the ion concentrated liquid 93 recovered in the salt recovery vessel 9c is a salt solution. The salt solution has a neutral ph and little influence on a human body or environment in handling, and can be thus easily transported and be disposed of. Also, salt can be recovered from

An operation and an effect of this embodiment are the same as those of the above described embodiment except the additional matter mentioned above.

As a variant of this embodiment, configurations of the negative ion permeable membrane and the positive ion permeable membrane may be changed depending on ionic charges contained in the water to be treated. For example, when ions contained in the water to be treated are Na₂CO₃, the positive ion permeable membrane may have a surface area twice a surface area of the negative ion permeable membrane, or two cation cylinders may be provided. Electrolysis of the water to be treated causes positive ions and negative ions at a ratio of 2:1, but positive ions in an amount twice an amount of negative ions are concentrated in the cation cylinder, thereby increasing purity of the water to be treated from which the ions are removed, and allowing the salt recovery vessel to recover neutral concentrated water containing Na₂CO₃ salt, or salt.

### Third Embodiment

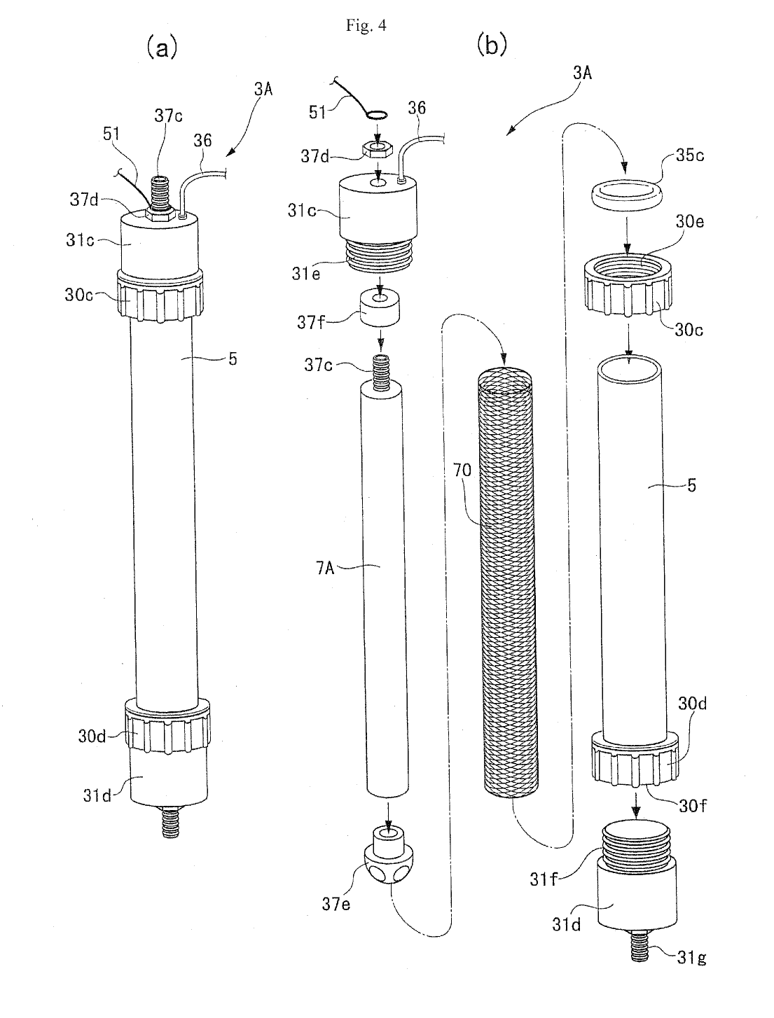

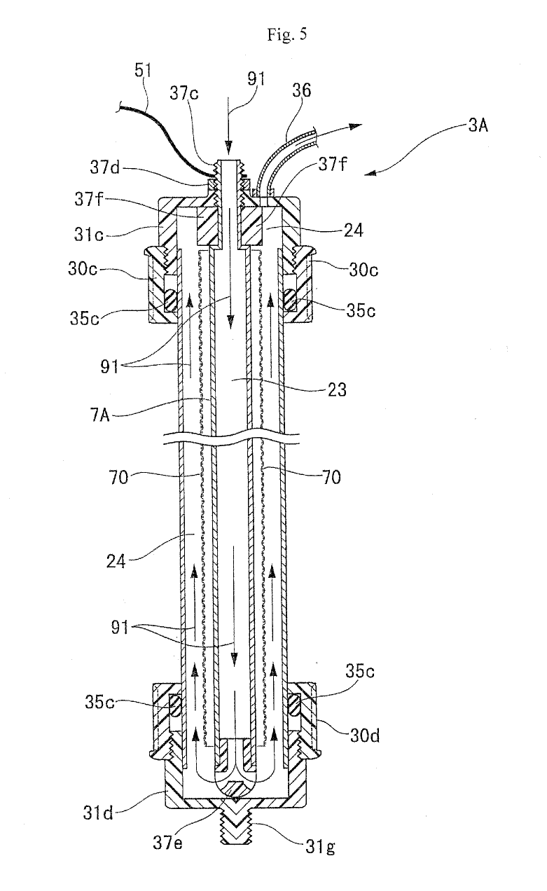

FIG. 4(a) is a perspective view of an anion cylinder in a third embodiment of the present invention, and FIG. 4(b) is an exploded view thereof. FIG. 5 is a side sectional view showing an operation of the anion cylinder in FIG. 4. An anion cylinder 3A in this embodiment is configured so that a cylindrical anode 7A is inserted through a cylindrical negative ion permeable membrane 5, and opposite ends of the negative ion permeable membrane 5 are sealed by a pair of cylindrical bodies 31c, 31d.

As shown in FIG. 4(b), the anode 7A is fitted to the body 31c of the pair of bodies 31c, 31d. The anode 7A is cylindrical, and a liquid inlet port 37c is welded to one end. A liquid inlet port 37c is cylindrical with a smaller diameter than the anode 7A and is threaded. A bottom spacer 37e made of resin is fitted into the other end of the anode 7A. The bottom spacer 37e has a hollow mushroom shape, and a stalk has substantially the same inner diameter as the anode 7A, and can be fitted in the anode 7A. A cap has a through hole, and a hollow portion communicates with an outside. An end spacer 37f is fitted on the liquid inlet port 37c. The end spacer 37f is made of vinyl chloride, and is cylindrical with substantially the same inner diameter as an outer diameter of

The anode 7A is inserted through an insulating net 70. The insulating net 70 is a mesh-like cylinder made of polypropylene, and has a slightly larger inner diameter than the anode 7A and a slightly shorter length than the anode 7A.

The body 31c is inserted through the liquid inlet port 37c. The body 31c is cylindrical with a larger inner diameter than the outer diameter of the anode 7A, and has an insertion hole through which the liquid inlet port 37c can be inserted at an end closing one end of the cylinder. The liquid inlet port 37c is inserted through the insertion hole, and a nut 37d is fastened on the threads on the liquid inlet port 37c to hold and fasten the body 31c between the anode 7A and the end spacer 37f. The end closing one end of the cylinder provides communication between a space 24 in the cylinder and the pipe 36 through a communication hole.

The electrification line 51 is electrically connected to one of threads on the liquid inlet port 37c. In this embodiment, the electrification line 51 is soldered, but may be merely wound so as to be easily disassembled again. An end of a cylinder of the liquid inlet port 37c is connected to a pipe 37 that is an inlet port of the ion concentrated water 91.

The other body 31d is cylindrical with one end having a larger inner diameter than the cylinder of the anode 7A, and includes a body screwing portion 31f having a smaller radius than other portions and threaded. The other end of the cylinder is closed and includes a securing portion 31g that is a threaded protruding end. The securing portion 31g can be screwed to a member having a screw hole to secure the anion cylinder 3A. In this embodiment, a screw hole can be provided in a bottom of the treatment vessel 2 to secure the anion cylinder 3A to the treatment vessel 2.

The negative ion permeable membrane 5 is cylindrical, and has opposite ends fastened by the sealing members 30c, 30d. The sealing members 30c, 30d each have a ring shape, water-tightly fasten the negative ion permeable membrane 5 at substantially a middle of the inner diameter via a ring-like fastening member 35c made of rubber, and sealing and screwing portions 30e, 30f having threads that can engage threads on a body screwing portion 31e are each formed on a remaining part of the inner diameter.

When the anion cylinder 3A is assembled, as shown in FIG. 4(b), the anode 7A is inserted through the insulating net 70, and then the negative ion permeable membrane 5, and the body screwing portion 31e of the body 31c is screwed to the sealing and screwing portion 30e. The other end of the anode 7A is inserted through the other body 31d to screw the body screwing portion 31f to the sealing and screwing portion 30f. The bottom spacer 37e of the anode 7A abuts against a closed end of the body 31d.

As shown in FIG. 5, when the ion concentrated water 91 is passed from the liquid inlet port 37cinto the anion cylinder 3A, the ion concentrated water 91 flows through a cylindrical space 23 in the cylindrical anode 7A, and then flows from a lower end of the anode 7A through a though hole in the bottom spacer 37e, and in the space 24 between an outside of the cylinder of the anode 7A and an inside of the cylinders of the negative ion permeable membrane 5, and the bodies 31d, 31c. Negative ions in the water to be treated 20 outside the anion cylinder 3A (FIGS. 1 and 3) are moved toward the anode 7A by charges of the anode 7A, and pass through the negative ion permeable membrane 5. The negative ions are concentrated into the ion concentrated water 91 passing through the space 24.

In this embodiment, the cation cylinder 4 has the same respective configuration as the anion cylinder except using a cathode 8 and a positive ion permeable membrane 6.

In this embodiment, the liquid inlet port 37c and the pipe 36 are placed at one end of the anion cylinder 3A, and the ion concentrated water 91 can be. introduced and discharged from one end, thereby facilitating placement in the treatment vessel 2, and saving space. This also facilitates maintenance or replacement by detaching the anion cylinder 3A from inside the treatment vessel 2. In the anion cylinder 3A, the anode 7A and the negative ion exchange membrane 5 are assembled into a cartridge by screwing, thereby facilitating replacement of the anode 7A and the negative ion permeable membrane 5. The anion cylinder 3A can be secured to the treatment vessel 2 by screwing of the securing portion 31g, thereby facilitating attachment and detachment. Thus, soiling or wear can be measured easily, and soiling or wear in replacement rarely occurs. Water with high purity can be produced, thereby facilitating maintenance.

The securing portion 31g may be fitted by a wedge or elasticity of rubber or the like other than screwing. For example, an outer diameter of the body 37d may be a securing portion 31g, a cylindrical fitting member having substantially the same inner diameter as the outer diameter of the body 37d may be provided on the bottom of the treatment vessel 2, and the body 37d may be fitted in the fitting member to secure the anion cylinder 3A to the treatment vessel 2. The body 37d can be easily detached by elasticity of the fitting member, thereby facilitating maintenance.

### Fourth Embodiment

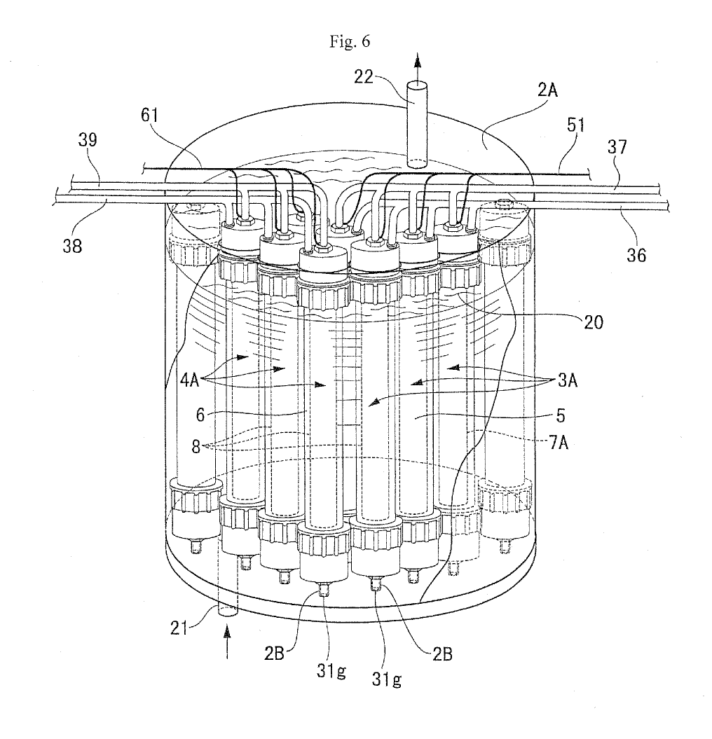

FIG. 6 is a partially fragmentary perspective view showing a treatment vessel in a fourth embodiment of the present invention. In this embodiment, anion cylinders 3A and cation cylinders 4A of substantially the same number are vertically placed in spreading manner in a treatment vessel 2A so that bottom surfaces of the cylinders cover a substantially entire bottom surface of the treatment vessel 2A. The anion cylinder 3A and the cation cylinder 4A are the same as those described in the third embodiment, and other configurations are the same as those in the first embodiment. In the shown example, eight anion cylinders 3A and eight cation cylinders 4A, a total of 16 cylinders are placed, and electrodes are connected to a power supply in parallel. The anion cylinder 3A and the cation cylinder 4A are screwed by securing portions 31g to screw holes 2b provided in the bottom surface of the treatment vessel 2A.

In this embodiment, the largest number of anion cylinders 3A and cation cylinders 4A are placed for a bottom area of the treatment vessel 2A, thereby increasing an effect of removing ions. Other configurations and operations and effects are the same as in the embodiment shown in FIG. 1.

The embodiments described above are all illustrative and not restrictive of the present invention, and the present invention may be carried out in various other variants or modifications. Therefore, the scope of the present invention is defined only by claims and equivalent thereof.

### Industrial Applicability

The present invention is useful for producing daily life water such as drinking water or industrial water, also treating various kinds of daily life water and waste liquid in various industries, and recovering substances contained in the water by electrolysis, and can be applied both in large and small scales. Thus, the present invention is extensively useful in fields requiring water, and contributes to life and industries and also to solving environmental problems.

### Reference Signs List

1, 1A water electrolysis apparatus

2, 2A treatment vessel

2b screw hole

3, 3A anion cylinder

4 cation cylinder

5 negative ion permeable membrane

6 positive ion permeable membrane

7, 7A anode

8 cathode

9a negative ion recovery vessel

9b positive ion recovery vessel

9c salt recovery vessel

20 water to be treated

21 inlet port

22 outlet port

23, 24 space

30a, 30b, 30c, 30d, 40a, 40b sealing member

30e, 30f sealing and screwing portion

31a, 31b, 31c, 31d body

31e body screwing portion

31g securing portion

32a anion cylinder outlet

32b anion cylinder inlet

33a, 33b connecting portion

34a, 34b fitting portion

35a, 35b, 35c fastening member

36, 36b, 37, 37b, 38, 39 pipe

37c liquid inlet port

37d nut

37e bottom spacer

37f end spacer

51, 61 electrification line

70 insulating net

90a, 90b valve

91, 92, 93 ion concentrated liquid

1. A water electrolysis apparatus comprising:
a treatment vessel;
at least one anion cylinder having a cylindrical negative ion permeable membrane provided in the treatment vessel;
at least one cation cylinder having a cylindrical positive ion permeable membrane provided in the treatment vessel;
an anode provided in the cylindrical negative ion permeable membrane in an axial direction of the cylinder; and
a cathode provided in the cylindrical positive ion permeable membrane in an axial direction of the cylinder,
wherein water to be treated stored in the treatment vessel can flow in an axial direction of the cylinder of the at least one anion cylinder and the at least one cation cylinder in the treatment vessel, and
ion concentrated water with concentrated ion is obtained in the at least one anion cylinder and the at least one cation cylinder, and pure water is obtained in the treatment vessel,
wherein the treatment vessel has openings in an outer wall,
the at least one anion cylinder and the at least one cation cylinder include sealing members that respectively hold at least opposite ends of the cylinders of the negative ion permeable membrane and the positive ion permeable membrane and are configured so that at least a part of a side surface of the cylinder faces the water to be treated, and parts of the sealing members are configures to be fitted to the openings so that the at least one anion cylinder and the at least one cation cylinder can be detachably held.

2. The water electrolysis apparatus according to claim 1, wherein the water electrolysis apparatus is configured so that an amount of permeation of negative ions per unit time through the negative ion permeable membrane is equal to an amount of permeation of positive ions per unit time through the positive ion permeable membrane.

3. The water electrolysis apparatus according to claim 1, further comprising a single salt recovery vessel that is connected to an opening provided in at least one of ends of the at least one anion cylinder and the at least one cation cylinder and recovers the ion concentrated water.

4. The water electrolysis apparatus according to claim 1, further comprising two salt recovery vessels that are respectively connected to the at least one anion cylinder and the at least one cation cylinder and recover the ion concentrated water.

5. (canceled)

6. The water electrolysis apparatus according to claim 1, wherein the at least one anion cylinder or the at least one cation cylinder includes members that can be screwed to the sealing members at opposite ends of the cylinder of the negative ion permeable membrane or the positive ion permeable membrane.

7. The water electrolysis apparatus according to claim 1, wherein the at least one anion cylinder or the at least one cation cylinder includes, at a bottom surface, a securing portion that can be screwed or fitted to the treatment vessel.

8. The water electrolysis apparatus according to claim 1, wherein the at least one anion cylinder and the at least one cation cylinder have bottom surfaces secured to a bottom surface of the treatment vessel.

9. The water electrolysis apparatus according to claim 1, wherein the at least one anion cylinder and the at least one cation cylinder are a plurality of anion cylinders and a plurality of cation cylinders, and the plurality of anion cylinders and the plurality of cation cylinders are spreadingly placed to cover a part of the bottom surface of the treatment vessel.

10. The water electrolysis apparatus according to claim 1, where the cathode or the anode is cylindrical with an open lower end, the at least one anion cylinder or the at least one cation cylinder includes means for supplying the ion concentrated water from an upper end of the cylinder, and means for recovering the ion concentrated water from an upper end of the positive ion permeable membrane or the negative ion permeable membrane.
